(19) United States
(12) Patent Application Publication
(10) Pub. No.: US 2019/0026547 A1
(43) Pub. Date: Jan. 24, 2019

(54) System and Method for Detecting Skin in an Image

(71) Applicant: 4Sense, Inc., Delray Beach, FL (US)

(72) Inventor: Hai-Wen Chen, Lake Worth, FL (US)

(73) Assignee: 4Sense, Inc., Delray Beach, FL (US)

(21) Appl. No.: 15/655,019

(22) Filed: Jul. 20, 2017

(51) Int. Cl. G06K 9/00

(52) U.S. Cl. CPC G06K 9/00362; G06T 7/20; G06T 2207/30196; G06K 9/00523

(57) ABSTRACT

A camera for detecting human skin is described herein. The camera can include a processor and an image-sensor circuit, which can be configured to generate a frame of a monitoring area that can include data associated with multiple human targets in the monitoring area. The processor can be configured to receive the frame from the image-sensor circuit, compare spectral angles related to the human targets and extracted from the frame with a single skin-reference spectral angle, and based on the comparison of the spectral angles related to the human targets with the skin-reference spectral angle, segment out skin detections associated with the human targets.

### FIELD

The subject matter described herein relates to computer vision systems and more particularly, to computer-vision systems that can detect humans.

### BACKGROUND

In recent years, several computer-vision systems have been developed to help track human targets. These systems typically rely on visible-light cameras to track the targets. In one example, some of these cameras can distinguish targets from one another based on color features of the targets, such as the color of a shirt worn by a human. This technology is especially useful when a computer-vision system is simultaneously tracking multiple human targets in the same area. Even so, obtaining additional data about the detections (and their corresponding targets) may improve the operation of these systems.

### SUMMARY

A camera for detecting human skin is described herein. The camera can include a processor and an image-sensor circuit, which can be configured to generate a frame of a monitoring area that can include data associated with multiple human targets in the monitoring area. The processor can be configured to receive the frame from the image-sensor circuit, compare spectral angles related to the human targets and extracted from the frame with a single skin-reference spectral angle, and based on the comparison of the spectral angles related to the human targets with the skin-reference spectral angle, segment out skin detections associated with the human targets.

The processor can also be configured to estimate the skin-reference spectral angle based on a reference group of humans and to estimate a threshold for the skin-reference spectral angle. As an example, the processor can be further configured to segment out the skin detections associated with the human targets when the spectral angles related to the human targets fall within the threshold for the skin-reference spectral angle. The processor can also be configured to store the skin-reference spectral angle and compare spectral angles related to the human targets in the monitoring area and extracted from a future frame with the skin-reference spectral angle. The future frame may include data associated with the human targets. The processor can be further configured to compare spectral angles related to new human targets in the monitoring area and extracted from another future frame with the skin-reference spectral angle in which the other future frame includes data associated with the new human targets.

In some cases, the processor can be further configured to classify the skin detections associated with the human targets into one or more body-part classifications. As an example, the processor can be configured to classify the skin detections based on one or more parameters of the skin detections. Examples of the parameters include the size, shape, or position of the skin detections.

Another camera for detecting human skin is described herein. The camera can include a processor and an image-sensor circuit, which can be configured to generate a frame of a monitoring area that includes data associated with multiple human targets in the monitoring area. The processor can be configured to receive the frame from the image-sensor circuit and compare spectral angles related to the human targets and extracted from the frame with a first skin-reference spectral angle and a second skin-reference spectral angle. As an example, the first skin-reference spectral angle can be based on a first human-skin type, and the second skin-reference angle can be based on a second human-skin type. The processor can be further configured to, based on the comparison of the spectral angles related to the human targets with the first skin-reference spectral angle and the second skin-reference spectral angle, segment out skin detections associated with the human targets.

In one arrangement, the first skin-reference spectral angle can be a light-skin-reference spectral angle, and the first human-skin type can be a light-skin type. In addition, the second skin-reference spectral angle can be a dark-skin reference spectral angle, and the second human-skin type can be a dark-skin type. As an example, a portion of the human targets may have light-skin types, and another portion of the human targets may have dark-skin types. In such an example, the skin detections associated with the human targets segmented out by the processor can include both light-skin detections and dark-skin detections.

The processor can be further configured to estimate the light-skin reference spectral angle based on a reference group of humans with light-skin types and estimate a light-skin threshold for the light-skin reference spectral angle. The processor can also be configured to estimate the dark-skin reference spectral angle based on a reference group of humans with dark-skin types and estimate a dark-skin threshold for the dark-skin reference spectral angle. In one embodiment, the processor can be configured to segment out the light-skin detections when the spectral angles related to the human targets fall within the light-skin threshold for the light-skin-reference spectral angle and segment out the dark-skin detections when the spectral angles related to the human targets fall within the dark-skin threshold for the dark-skin-reference spectral angle.

As an example, both the light-skin reference spectral angle and the dark-skin reference spectral angle may be reusable for comparisons with spectral angles extracted from future frames of the monitoring area or a new monitoring area. As another example, the light-skin threshold may be constant with respect to the light-skin reference spectral angle, and the dark-skin threshold may be constant with respect to the dark-skin reference spectral angle. In addition to being constant with respect to the light-skin reference spectral angle, the light-skin threshold may be constant with respect to the monitoring area or a new monitoring area. In addition to being constant with respect to the dark-skin reference spectral angle, the dark-skin threshold can be constant with respect to the monitoring area or the new monitoring area.

In one embodiment, the processor can be further configured to classify the skin detections based on one or more parameters of the skin detections. Examples of the parameters can include the size, shape, or position of the skin detections.

A method of detecting human skin is described herein. The method can include the steps of receiving a frame that includes data associated with multiple human targets in a monitoring area, extracting from the frame spectral angles related to the human targets, and comparing the spectral angles related to the human targets with a first skin-reference spectral angle. Based on comparing the spectral angles related to the human targets with the first skin-reference spectral angle, skin detections associated with the human targets can be segmented out. The method can also include the steps of comparing the spectral angles related to the human targets with a second skin-reference spectral angle and based on comparing the spectral angles related to the human targets with the second skin-reference spectral angle, segmenting out additional skin detections associated with the human targets.

The method can also include the steps of estimating the first skin-reference spectral angle based on a first set of skin colors and estimating the second skin-reference spectral angle based on a second set of skin colors. The method can further include the step of classifying the skin detections based on one or more parameters of the skin detections. Examples of the parameters can include the size, shape, or position of the skin detections.

### BRIEF DESCRIPTION OF THE DRAWINGS

FIG. 1 illustrates a block diagram of an example of a camera for detecting human skin.

FIG. 2 illustrates an example of a monitoring area.

FIG. 3 illustrates an example of a method for detecting human skin.

FIG. 4 illustrates an example of a reference group of human targets in a monitoring area.

FIG. 5 illustrates an example of a red-green-blue (RGB) frame that presents several full-body detections.

FIG. 6 illustrates another example of an RGB frame that presents several full-body detections.

FIG. 7 illustrates another example of an RGB frame that presents several full-body detections and skin detections related to the full-body detections.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously mentioned, computer-vision systems and other related technologies require information that is useful for tracking humans and identifying certain events or actions associated with them. In some cases, identifying portions of skin from images of human targets may assist in this process.

To achieve such a solution, a camera for detecting human skin is described herein. The camera can include a processor and an image-sensor circuit, which can be configured to generate a frame of a monitoring area that can include data associated with multiple human targets in the monitoring area. The processor can be configured to receive the frame from the image-sensor circuit, compare spectral angles related to the human targets and extracted from the frame with a skin-reference spectral angle, and based on the comparison of the spectral angles related to the human targets with the skin-reference spectral angle, segment out skin detections associated with the human targets.

As such, the camera can rely on a single skin-reference spectral angle to segment out skin detections from multiple human targets, each with different shades of skin color. In some cases, an additional and separate skin-reference spectral angle can be used to segment out skin detections from some of the multiple human targets who have skin colors that are significantly different from others in the group. As an option, the camera can be further configured to classify such skin detections as one of a set of possible body parts. Valuable information can be obtained from these processes, which can improve the operation of computer-vision systems and other similar technologies.

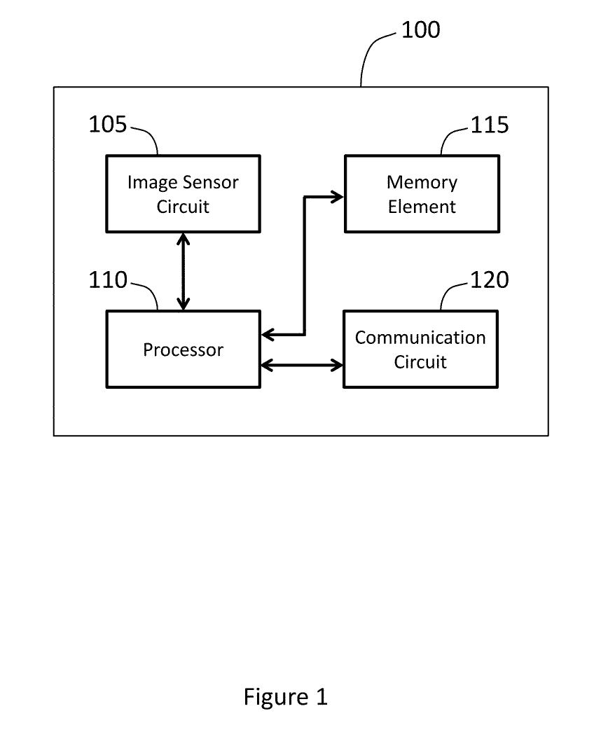

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or originating or reflected from a living being, composition, machine, etc. or are otherwise sensitive to variations in one or more phenomena associated with such living being, composition, machine, etc. and provide some signal or output that is proportional or related to the stimuli or the variations. An “image-sensor circuit” is defined as a sensor that receives and is sensitive to at least visible light and generates signals for creating images, or frames, based off the received visible light. An “object” is defined as any real-world, physical object or one or more phenomena that results from or exists because of the physical object, which may or may not have mass. An example of an object with no mass is a human shadow. A “target” is defined as an object or a representation of an object that is being or is intended to be passively tracked. Examples of targets include humans, animals, or machines. The term “monitoring area” is an area or portion of an area, whether indoors, outdoors, or both, that is the actual or intended target of observation or monitoring for one or more sensors.

A “frame” (or “image”) is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object (or a target) or the presence of visible light in a monitoring area or other location.

A “processor” is defined as a circuit-based component or group of circuit-based components that are configured to execute instructions or are programmed with instructions for execution (or both) to carry out the processes described herein, and examples include single and multi-core processors and co-processors. The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols.

The term “communicatively coupled” is defined as a state in which signals may be exchanged between or among different circuit-based components, either on a unidirectional or bidirectional basis, and includes direct or indirect connections, including wired or wireless connections. A “hub” is defined as a circuit-based component in a network that is configured to exchange data with one or more passive-tracking systems or other nodes or components that are part of the network and is responsible for performing some centralized processing or analytical functions with respect to the data received from the passive-tracking systems or other nodes or components.

A “camera” is defined as an instrument for capturing images and operates in the visible-light spectrum, the non-visible-light spectrum, or both. A “red-green-blue camera” or an “RGB camera” is defined as a camera whose operation is based on the principle of the visible red-blue-green (RGB) color spectrum in which red, green, and blue light are added together in various ways to form a broad array of colors. A “pixel” is defined as the smallest addressable element in an image. A “color pixel” is defined as a pixel based on a combination of one or more colors.

The term “digital representation” is defined as a representation of an object (or target) in which the representation is in digital form or otherwise is capable of being processed by a computer. A “human-recognition feature” is defined as a feature, parameter, or value that is indicative or suggestive of a human or some portion of a human. Similarly, a “living-being-recognition feature” is defined as a feature, parameter, or value that is indicative or suggestive of a living being or some portion of a living being. The word “skin” is defined as tissue that forms the natural outer covering of the body of a person or animal. The term “exposed skin” is defined as skin that is uncovered, such as by a garment or a blanket.

A “detection” is defined as a representation of an object (or target) and is attached with or includes data related to one or more characteristics of the object (or target). A detection may exist in digital or visual form (or both). A “full-body detection” is a detection that represents an object (or target) in its entirety or its intended entirety. A “skin detection” is defined as a detection that represents exposed skin of an object (or target). A “light-skin detection” is defined as a skin detection in which the exposed skin falls within or is classified by one or more light-skin types. A “dark-skin detection” is defined as a skin detection in which the exposed skin falls within or is classified by one or more dark-skin types. A “false detection” is defined as a detection that does not correspond to a target or is not intended to be tracked. The term “segment out” is defined as to detect, recognize, identify, discover, discern, distinguish, perceive, isolate, or ascertain a body in comparison to a larger body, whether the body is part of the larger body or not.

The term “color vector” is defined as a vector whose direction is determined by the color of the object (or target) with which the vector is associated, such as by a color pixel corresponding to the object (or target). The term “reference spectral angle” is defined as a spectral angle based on a collective RGB value against which the spectral angles of pixels are compared. The term “skin-reference spectral angle” is defined as a reference spectral angle in which the collective RGB value is based on pixels associated with the skin of one or more targets. A “light-skin-reference spectral angle” is defined as a skin-reference spectral angle in which the skin of the targets is defined by one or more light-skin types. A “dark-skin-reference spectral angle” is defined as a skin-reference spectral angle in which the skin of the targets is defined by one or more dark-skin types. The term “skin type” is defined as a category that defines one or more characteristics of a skin color or a range of skin colors.

A “threshold” is defined as a value, parameter, condition, point, or level used for comparative purposes. The term “light-skin threshold” is defined as a threshold for a light-skin-reference spectral angle. The term “dark-skin threshold” is defined as a threshold for a dark-skin reference spectral angle. A “body-part classification” is defined as an assignment, determination, designation, labeling, arrangement, ordering, sorting, ranking, rating, grouping, or categorization based on predetermined parts of a body, whether that of a human, an animal, or a machine.

The term “three-dimensional position” is defined as data that provides in three dimensions the position of an element in some setting, including real-world settings or computerized settings. The term “two-dimensional position” is defined as data that provides in two dimensions the position of an element in some setting, including real-world settings or computerized settings. The term “periodically” is defined as recurring at regular or irregular intervals or a combination of both regular and irregular intervals. The term “confidence factor” is defined as one or more values or other parameters that are attached or assigned to data related to a measurement, calculation, analysis, determination, finding, or conclusion and that provide an indication as to the likelihood, whether estimated or verified, that such data is accurate or plausible.

The word “generate” or “generating” is defined as to bring into existence or otherwise cause to be. The word “distinguish” or “distinguishing” is defined as to recognize as distinct or different or to set apart or identify as distinct or different. The word “estimate” or “estimating” is defined as to approximately or accurately calculate or otherwise obtain or retrieve one or more values. The word “compare” or “comparing” is defined as to estimate, measure, determine, or record the similarity or dissimilarity (or both) between one or more objects, values, parameters, events, or criterion. The word “extract” or “extracting” is defined as to obtain, get, retrieve, acquire, receive, or remove. The word “classify” or “classifying” is defined as to assign, determine, designate, label, arrange, order, sort, rank, rate, group, or categorize. The word “constant” is defined as fixed or substantially fixed with deviations of plus or minus ten percent or less.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses all possible combinations of one or more of the associated listed items. As an example, the phrase “at least one of A, B and C” includes A only, B only, C only, or any combination thereof (e.g. AB, AC, BC or ABC). Additional definitions may be provided throughout this description.

Referring to FIG. 1, a block diagram of an example of a camera 100 for identifying human skin is shown. The camera 100 can include one or more image-sensor circuits 105, one or more processors 110, one or more circuit-based memory elements 115, and one or more communication circuits 120. Each of the foregoing devices of the camera 100 can be communicatively coupled to the processor 110 and to each other, where necessary. Although not pictured here, the camera 100 may also include other components to facilitate its operation, like power supplies (portable or fixed), heat sinks, displays or other visual indicators (like LEDs), speakers, and supporting circuitry.

The image-sensor circuit 305 can be any suitable component for receiving light and converting it into electrical signals for generating images (or frames). Examples include a charge-coupled device (CCD), complementary metal-oxide semiconductor (CMOS), or N-type metal-oxide semiconductor (NMOS).

The processor 110 can oversee the operation of the camera 100 and can coordinate processes between all or any number of the components of the camera 100. Any suitable architecture or design may be used for the processor 110. For example, the processor 110 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The processor 110 can include at least one hardware circuit (e.g., an integrated circuit) configured to carry out instructions contained in program code.

In arrangements in which there is a plurality of processors 110, such processors 110 can work independently from each other or one or more processors 110 can work in combination with each other. In one or more arrangements, the processor 110 can be a main processor of some other device, of which the camera 100 may or may not be a part. This description about processors may apply to any other processor that may be part of any system or component described herein, including any of the individual components of the camera 100. Moreover, other components of the camera 100, irrespective of whether they are shown here, may be integrated or attached to the camera 100 as an individual unit, or they may be part of some other device or system or completely independent components.

The circuit-based memory elements 115 can be include any number of units and type of memory for storing data. As an example, a circuit-based memory element 115 may store instructions and other programs to enable any component, device, sensor, or system of the camera 100 to perform its functions. As an example, a circuit-based memory element 115 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 115 can be part of the processor 110 or can be communicatively connected to the processor 110 (and any other suitable devices) for use thereby. In addition, any of the various other parts of the camera 100 may include one or more circuit-based memory elements 115.

In one arrangement, the camera 100 may be a red-green-blue (RGB) camera, meaning that it has several bandpass filters configured to permit light with wavelengths that correspond to these colors to pass through to the image-sensor circuit 105. In a typical RGB camera, the wavelength associated with the peak value for blue is around 430 nanometers (nm), green is about 550 nm, and red is roughly 620 nm. Of course, these wavelengths, referred to as central wavelengths, may be different for some RGB cameras, and the processes described herein may be performed irrespective of their values. In addition, the RGB camera may be configured with additional bandpass filters to allow light in other spectral bands to pass, including light within and outside the visible spectrum. For example, the RGB camera may be equipped with a near infra-red bandpass filter (NIR) to enable light in that part of the spectrum to reach the image-sensor circuit 105. As an example, the NIR wavelength associated with peak value may be around 850 nm, although other wavelengths may be used.

In some cases, adjustments can be made after the initial setting of the central wavelengths. For example, the central wavelength for red may be moved from 620 nm to 650 nm, such as by placing an additional filter over the existing bandpass filter or re-programming it. In fact, the RGB camera may be reconfigured to block out light in any of the existing RGB spectral bands and may continue to provide useful data if at least two spectral bands remain. In addition, the camera 100 is not necessarily limited to an RGB camera, as the camera 100 may employ any number and combination of spectral bands for its operation. As the number of spectral bands increases, the ability of the camera 100 to detect objects may improve, although a balance should be maintained because the processing of the additional information increases the computational complexity of the camera 100, particularly if moving targets are involved.

No matter the configuration of the camera 100, the processor 110 may acquire spectral-band values from the input of the image-sensor circuit 105 that are based on the light received by the image-sensor circuit 105. The processor 110 may acquire these values by generating or determining them itself (based on the incoming signals from the image-sensor circuit 105) or receiving them directly from the image-sensor circuit 105. For example, in the case of an RGB camera, the image-sensor circuit 105 may provide the processor 110 with three RGB values for each pixel. The collection of the RGB values for the pixels may be part of an image, or frame, that represents the subject matter captured by the image-sensor circuit 105, and additional operations may be performed on this image later, as will be explained below.

As an example, the camera 100 may be positioned in a monitoring area 110 and can be configured to detect certain objects, like humans. Such humans may be referred to as human targets or simply, targets. As part of this detection, the camera 100 can be configured to distinguish between different targets and to track them over time. In one arrangement, the camera 100 may be part of or independently configured as a passive-tracking system for passively tracking human targets or other objects. Additional information on such a system and its features can be found in U.S. Pat. No. 9,638,800, issued on May 2, 2017, which is herein incorporated by reference.

In some cases, the camera 100 may be part of a network (not shown) in which the camera 100 transmits or receives (or both) data and commands with other cameras 100, systems, or devices, which can be referred to as network-based components. The network may also include one or more hubs (not shown), which may be communicatively coupled to any of the camera 100 and any other network-based component. The hubs may process data received from the camera 100 and network-based components and may provide the results of such processing to them or other systems. To support this data exchange, the camera 100, the network-based components, and the hubs may be configured to support wired or wireless (or both) communications in accordance with any acceptable standards. The network-based components and the hubs may be positioned within or outside (or a combination of both) any area served by the camera 100. As such, the network-based components and the hubs may be considered local or remote, in terms of location and being hosted, for a network.

As noted above, the camera 100 may be configured to detect human skin. As part of this operation, the camera 100, may be configured to detect and track human targets. The camera 100, however, can be configured to detect and track other objects, such as other living beings. Examples of other living beings include animals, like pets, service animals, animals that are part of an exhibition, etc. Although plants are not capable of movement on their own, a plant may be a living being that is detected and tracked or monitored by the system described herein, particularly if it has some significant value and may be vulnerable to theft or vandalism. An object may also be a non-living entity, such as a machine or a physical structure, like a wall or ceiling. As another example, an object may be a phenomenon that is generated by or otherwise exists because of a living being or a non-living entity, such as a shadow, disturbance in a medium (e.g., a wave, ripple or wake in a liquid), vapor, or emitted energy (like heat or light).

In one arrangement, the camera 100 may be assigned to a certain area, referred to as a monitoring area. As an example, a monitoring area may be an enclosed or partially enclosed space, an open setting, or any combination thereof. Examples include man-made structures, like a room, hallway, vehicle or other form of mechanized transportation, porch, open court, roof, pool or other artificial structure for holding water or some other liquid, holding cells, or greenhouses. Examples also include natural settings, like a field, natural bodies of water, nature or animal preserves, forests, hills or mountains, or caves. Examples also include combinations of both man-made structures and natural elements.

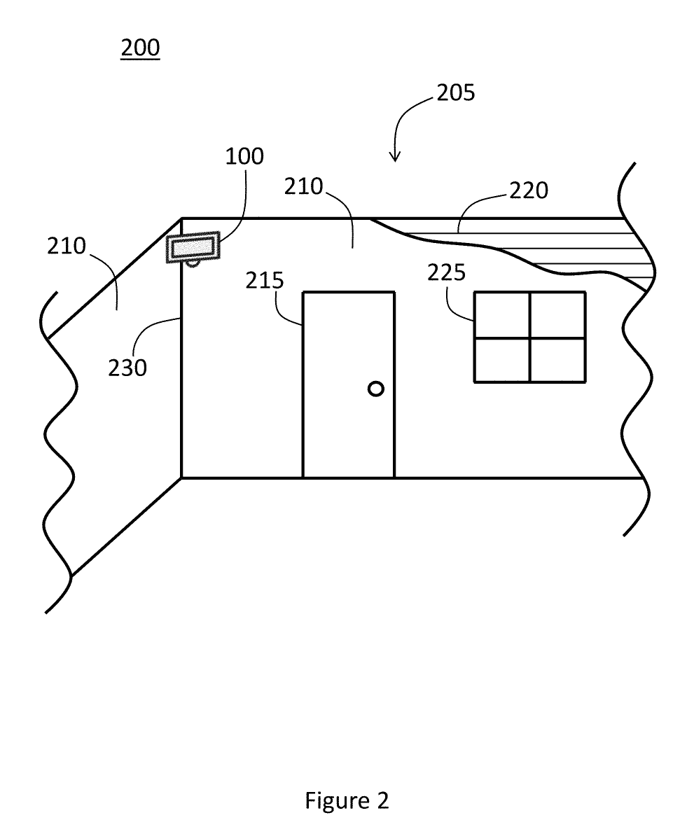

Referring to FIG. 2, an example of a monitoring area 200 in the form of an enclosed room 205 (shown in cut-away form) is presented. The room 205 may have several walls 210, an entrance 215, a ceiling 220 (also shown in cut-away form), and one or more windows 225, which may permit natural light to enter the room 205. Although coined as an entryway, the entrance 215 may be an exit or some other means of ingress and/or egress for the room 205. In one embodiment, the entrance 215 may provide access (directly or indirectly) to another monitoring area (not shown), such as an adjoining room or one connected by a hallway. In such a case, the entrance 215 may also be referred to as a portal, particularly for a logical mapping scheme. In this example, the camera 100 may be positioned in a corner 230 of the room 205 or in any other suitable location. As will be explained below, the camera 100 can be configured to detect skin of one or more human targets that enter the monitoring area 200.

Any number of cameras 100 may be assigned to the monitoring area 200, and a camera 100 may not necessarily be assigned to monitor a particular area, as detection and tracking could be performed for any particular setting in accordance with any number of suitable parameters. Moreover, the camera 100 may be fixed in place in or proximate to a monitoring area 200, although the camera 100 is not necessarily limited to such an arrangement. For example, one or more cameras 100 may be configured to move along a track or some other structure that supports movement or may be attached to or integrated with a machine capable of motion, like a drone, vehicle, or robot.

As noted earlier, the camera 100 may be configured to detect human skin. As an example, one or more human targets may enter the monitoring area 200, and the camera 100 may detect one or more portions of skin associated with the targets. The camera 100 may also be configured to classify the detected skin into one of one or more body-part categories. The camera 100 may be configured to detect skin associated with many different targets, each of whom may have different shades of skin color.

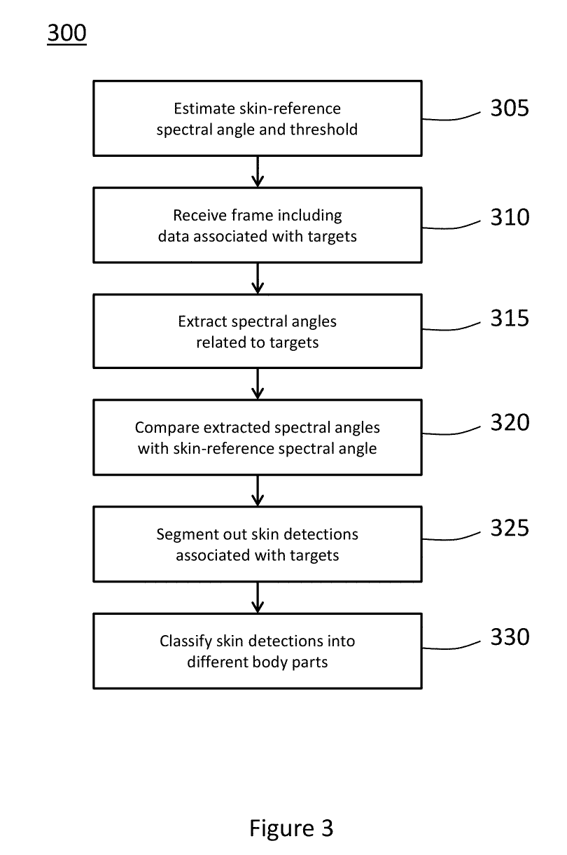

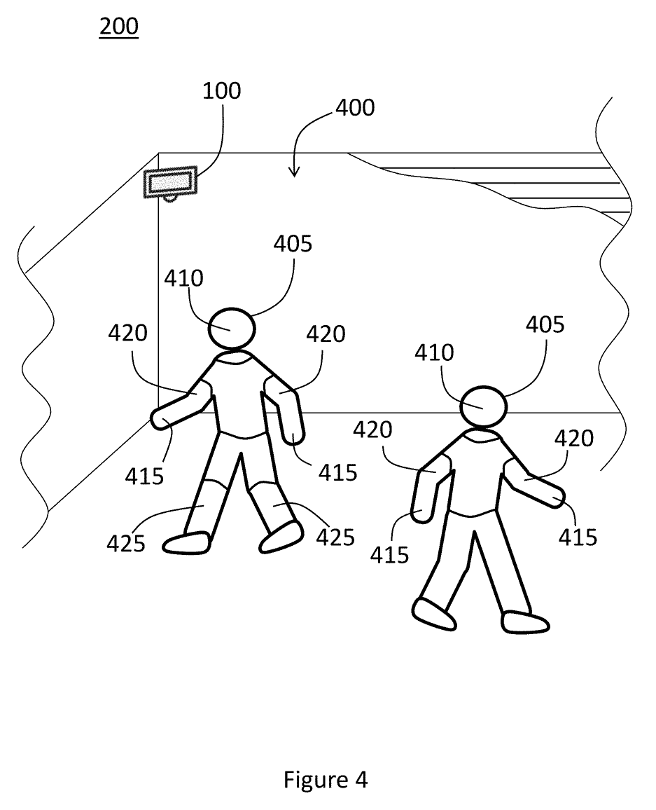

Referring to FIG. 3, an example of a method 300 for detecting human skin is illustrated. The method 300 may include additional steps, beyond those presented here, and may not necessarily require all the steps so presented. Moreover, the method 300 is not necessarily limited to this chronological order, as any of the steps of the method 300, regardless of whether they are shown here, may be in any suitable order. To assist in the explanation of the method 300, reference may be made to FIGS. 1 and 2, although the method 300 may be practiced with other suitable devices or systems and in other settings. In addition, reference may be made to FIGS. 4-7, each of which will be presented below, to provide (non-limiting) details and context for the method 300.

Initially, at step 305, one or more skin-reference spectral angles and one or more thresholds for the skin-reference spectral angles can be estimated. In one arrangement, these estimates may be based on one or more reference groups of humans. Referring to FIG. 4, a reference group 400 in a monitoring area 200 is shown, and the reference group 400 may include one or more human targets 405. The monitoring area 200 can be the one presented in FIG. 2, although the method may be practiced in other monitoring areas. The human targets 405 here are presented in a physical (not digital) sense, and the human targets 405 may expose some portion of their skin. This exposure can be realized from normal behavior or can be intentional in nature. For example, each of the human targets 405 may have their faces 410, hands 415, and arms 420 exposed, and some of the targets 405 may exhibit bare legs 425, such as from wearing shorts or skirts. As another example, at least some of the targets 405 may intentionally expose portions of their flesh, such as by rolling up their shirt sleeves, on a temporary basis for purposes of the estimations. In either case, the camera 100 can capture images of the targets 405. Based on these images, one or more reference color vectors may be estimated, which can be used to segment out skin detections, as will be shown below.

As part of the estimation process, initially, the camera 100 may realize full-body detections associated with the targets 405. Information on such a process can be found in U.S. patent application Ser. No. 15/597,941 (the “'941 application”), filed on May 17, 2017, and “Moving Human Full-Body and Body-Parts Detection, Tracking, and Applications on Human Activity Estimation, Walking Pattern and Face Recognition,” Hai-Wen Chen and Mike McGurr, Automatic Target Recognition XXVI, Proc. of SPIE, Vol. 9844, pages 98440T-1 to 98440T-34, published in May 2016 (referred to as the “Chen Publication” for the rest of this document), both of which are herein incorporated by reference. Nevertheless, a summary of acquiring full-body detections will be presented here.

When a current frame containing digital representations of the targets 405 is received, the background clutter of the current frame can be removed (or filtered out). As an example, the current frame can be set as a reference frame, and a previous frame, which may also include digital representations of the targets 405, can be subtracted from the current frame to suppress static background clutter. Following the removal of the background clutter, a current RGB frame may include the RGB values related to several detections, some of which may correspond to the targets 405. Other detections, however, may not be related to the targets 405, and these detections may be referred to as false detections. These RGB values may be normalized values. This data may be set aside for later retrieval and comparative analysis, as will be explained below. A detection process may be performed with respect to the detections. Because this detection process focuses on the detections in their entireties, these detections may be referred to as full-body detections. Some of the full-body detections may correspond to the targets 405 in a monitoring area 200, but other full-body detections may result from false detections.

In one embodiment, to enable the detection process, the processor 110 may convert the RGB frame into a binary format, which can produce binary representations of the full-body detections. To do so, the processor 110 may initially transform the RGB frame into the hue-saturation-value (HSV) domain, thereby creating a hue (H) image, a saturation (S) image, and a value (V) image. Following the transformation, the processor 110 may focus on the S and V images and can throw out or ignore the H image. Binary images corresponding to the targets 405 may be segmented out from the S and V images based on their pixel values in relation to a probability-density function (PDF). In particular, those pixels with pronounced values on either side of a median value of the relevant PDF, because they may be pixels related to the targets 405, may be assigned a binary one. Conversely, those pixels with lower values on either side may be considered background pixels and may be assigned a binary zero. These pixels may be associated with background clutter. In one case, a constant threshold may be set for one or both sides of the median value of the S and V images to identify cutoff values for determining whether a pixel should be assigned a binary one or zero. Once the binary images are realized for the V and S images, a logical OR operation may be applied to the two images to form composite binary images that represent the targets 405. The composite binary images may be composed of pixels with binary-one or binary-zero values, with, for example, the binary-one values realized from either the V or S image.

As another option, the binary images may be realized by fusing the V image with a motion-vector image, instead of with an S image. In such a case, a logical AND operation may be applied to the V and motion-vector images to form the composite binary images that represent the targets 405. Using the V and motion-vector images may reduce the false-detection rate. This type of fusion may be particularly useful for targets 405 that are in motion during the estimation process. If a target 405 is stationary, however, the V and S images may be used to produce the composite binary images, as explained above.

To help control deviations and false detections, the processor 110 may perform morphological filtering on the composite binary images. As an example, the morphological filtering can include the operations of dilation, erosion, and opening. Following the morphological filtering, the processor 110 can execute a detection process in which the processor 110 generates one or more detection fields for each of the composite binary images. As an example, the detection fields can define certain values or parameters based on the grouping of pixels that define each of the composite binary images. Additionally, the detection fields may be part of a data structure attached to or part of a full-body detection, and the data structure can be referred to as detection data. In view of the link between a full-body detection and a composite binary image, the detection data may define certain parameters and values of the full-body detections and, hence, the corresponding targets 405. Although the description here focuses on full-body detections related to human targets, detection data may (in some cases) be generated for full-body detections that are unrelated to human targets, including those from false detections.

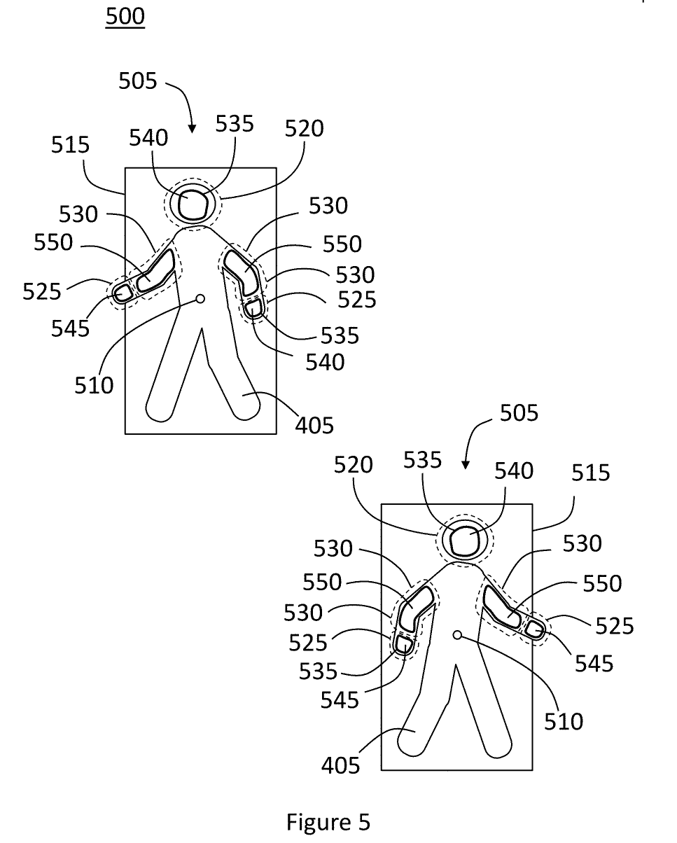

Referring to FIG. 5, an example of an RGB frame 500 that shows full-body detections 505 of the targets 405 is presented. The RGB frame 500 illustrated here is primarily intended to provide a visual realm to assist in the explanation of the detection data that may be estimated for the targets 405. For example, in relation to the full-body detections 505 of each target 405 and based on the composite binary images described above, the processor 110 may estimate the X and Y positions of a centroid 510 and X and Y positions for the four corners of a bounding box 515. The X and Y positions of the centroid 510 may be used to establish the position of the corresponding target 405 in the monitoring area 200. The processor 110 may also determine an X span and a Y span for the targets 405. The X span may provide the number of pixels spanning across the horizontal portion of a target 405, and the Y span may do the same for the vertical portion of the target 405.

As another example, the processor 110 may estimate a size, height-to-width (HWR) ratio (or length-to-width (LWR) ratio), and deviation from a rectangular shape for the targets 405. (These estimates may correspond to the number of pixels related to the full-body detections 505.) The deviation from a rectangular shape can provide an indication as to how much the grouping of pixels deviates from a rectangular shape. The detection fields may also include the X and Y positioning of pixels associated with the target 405. As an example, the X and Y positioning of all the pixels associated with the target 405 (i.e., the entire full-body detection 505) may be part of the detection data. As an option, the X and Y positioning of one or more subsets of pixels of all the pixels associated with the target 405 may be part of the detection data. The detection data may include other data in addition to the detection fields, and the number and type of detection fields are not necessarily limited to the examples shown here.

From this detection data, the processor 110 may estimate skin patches associated with the full-body detections 505 and, hence, the targets 405. For example, because the detection data of the targets 405 may include the X and Y positioning of the pixels related to the targets 405, the processor 110 may use a portion of the positioning data as a mask and conduct a logical AND operation between the portion of the positioning data and the original RGB frame, or RGB frame 500. From this operation, RGB values related to certain pixels may be extracted. (The RGB values may correspond to color vectors.) The processor 110 may estimate a reference color vector from the extracted RGB pixel values, which may be normalized, for the targets 405. In this case, the pixels that have their RGB values extracted may be related to portions of exposed skin of the targets 405, and the reference color vector may be a preliminary skin-reference color vector.

In one arrangement, the subsets of pixels corresponding to skin may be identified by reference to one or more detection fields of the detection data. For example, the processor 110 may designate pixels for the extraction based on their relation to the centroids 510 and the X and Y spans. Some of the designated pixels may be situated within a certain range (in pixels) above the centroids 510 and within certain ranges (in pixels) of the X and Y spans such that the pixels define an approximate skin section, such as an approximate face section 520 (with dashed boundaries) of each of the targets 405. (The face section 520 may or may not include a neck section.) As another example, some of the designated pixels may define approximate hand sections 525 because they have Y positions that are similar to the relevant centroid 510 and are near the edges of the X spans. Approximate arm sections 530 may be defined by pixels that have Y positions near and within a certain range above that of a centroid 510 and that are positioned near or within a certain range of the edges of the X spans. Similar designations may be performed for other pixels that correspond to body parts that are likely to be exposed, such as the legs of the targets 405, although other body parts may be considered.

From the extracted RGB values, the processor 110 may estimate a preliminary median RGB value, from which the preliminary skin-reference color vector may be generated. The preliminary skin-reference color vector may have a direction and a length, and the direction may define a preliminary skin-reference spectral angle. In view of this arrangement, the preliminary skin-reference color vector may be related to the colors of exposed skin of the targets 405. (Because the preliminary skin-reference color vector is realized from a median RGB value, the preliminary skin-reference color vector may be related to multiple colors.) Although the extraction of the RGB pixel values is described at this stage, it may occur earlier, such as during the initial detection process presented above.

In one embodiment, the processor 110 may be configured with a spectral angle mapper (SAM) solution. The SAM solution can be used to determine the spectral similarity between two spectra by calculating the angle between the spectra and treating them as vectors in a space with dimensionality equal to the number of spectral bands. The spectral angle between similar spectra is small, meaning the wavelengths of the spectra and, hence, the color associated with them are alike. Thus, a reference spectral angle, like the preliminary skin-reference spectral angle, may be useful for segmenting out a portion, or patch, of skin of a full-body detection in terms of color similarity among the pixels associated with the full-body detection.

Once the preliminary skin-reference color vector is generated, the processor 110 may use the X and Y positioning of all or a substantial portion of the pixels associated with the targets 405 as a mask to extract RGB values from the original RGB image. The processor 110 may then compare the spectral angles of the pixels associated with the targets 405 with the preliminary skin-reference spectral angle. The spectral angles of the pixels that are associated with the targets 405 that match the preliminary skin-reference spectral angle may define one or more skin patches, which can be segmented out. To be a match, a spectral angle of an extracted pixel value may be identical to the preliminary skin-reference spectral angle or may fall within a range that includes the preliminary skin-reference spectral angle. The range may be defined by one or more preliminary spectral-angle thresholds.

In this example, skin patches 535 (represented by solid lines) may be realized from the pixels associated with the face sections 520, hand sections 525, and arm sections 530 of one or more of the targets 405. The spectral angles of the extracted pixel values that do not match (either not identical or outside the spectral-angle threshold(s)) the preliminary skin-reference spectral angle may not correspond to the skin patches 535. In view of the accuracy of the SAM process and its application to all the pixels associated with the targets 405, the skin patches 535 that are segmented out here may be more reliable in representing the actual exposed skin of the targets 405 in comparison to the skin patches (e.g., the face sections 520, hand sections 525, and arm sections 530) that were previously approximated from the detection data. Also in this example, the skin patches 535 that are segmented out may be referred to as face patches 540 (which may or may not include a neck patch), hand patches 545, and arm patches 550. Other examples of skin patches 535 not shown here may be segmented out, such as leg patches or foot patches.

In one arrangement, the processor 110 may determine a second median RGB value from the skin patches 535 that are segmented out, in this case, the face patches 540, hand patches 545, and arm patches 550. From this second median RGB value, the processor 110 may estimate or determine a refined skin-reference color vector, from which a refined skin-reference spectral angle may be obtained. The term “refined” indicates that, because the second median RGB value originates from the skin patches 535, this additional skin-reference spectral angle may be a more accurate indicator of the actual skin color of the targets 405 in comparison to the preliminary skin-reference spectral angle. For brevity, however, the refined skin-reference color vector and the refined skin-reference spectral angle may be respectively referred to as the skin-reference color vector and skin-reference spectral angle. An example of the application of the skin-reference spectral angle will be shown below.

As an example, one or more thresholds can be estimated for the skin-reference spectral angle. Similar to a preliminary spectral-angle threshold, the threshold for the skin-reference spectral angle can serve as a cut-off value for determining whether the spectral angles of the pixels match the skin-reference spectral angle. For example, the processor 110 can be configured to segment out skin detections associated with the targets 405 (or other targets) when the spectral angles of the pixels corresponding to the targets 405 (or other targets) fall within the threshold for the skin-reference spectral angle. To fall within the threshold for the skin-reference spectral angle, the spectral angles may equal the value of the skin-reference spectral angle, be below or above such value, or equal and be below or above such value. In this example, a match includes a spectral angle with a value that equals or is below that of the skin-reference spectral angle. The value for the threshold of the skin-reference spectral angle can be estimated in several ways. For example, the processor 110 may select a predetermined value based on the second median RGB value or may calculate it based on the second median RGB value and other suitable factors, such as lighting conditions or the configuration of the monitoring area 200. These principles may also apply to the preliminary spectral-angle thresholds described above.

To increase the accuracy of the skin-reference spectral angle and its threshold, the process of estimating them can be repeated one or more times. For example, these parameters may be estimated for multiple frames that include data relating to the targets 405. The processor 110 may then adjust one or both of the initial estimations for the skin-reference spectral angle and its threshold. As part of this step, the processor 110 may determine a median value for the multiple skin-reference spectral angles and (possibly) their thresholds and may correspondingly modify the original skin-reference spectral angle and (possibly) its threshold. The use of multiple frames in this example may also increase the chances that each of the targets 405 may exhibit exposed skin or greater amounts of it. As an option, other targets 405 may be added (intentionally or not) to the reference group 400 while the estimation process is repeated. These new targets 405 may have skin colors that are different from or equivalent to (or a combination of both) the skin colors of the existing targets 405. As another option, one or more targets 405 may be removed (intentionally or not) from the reference group 400.

In one arrangement, the processor 110 may be configured to ignore certain spectral angle values of the pixels of the RGB image. This feature may be particularly useful during the estimation of the preliminary skin-reference spectral angle. When extracting the RGB values for purposes of estimating the preliminary median RGB value, the processor 110 can ignore RGB values that are outside a predetermined or otherwise acceptable range for skin of a human (or other animal). For example, if a target 405 is wearing green gloves, the extracted RGB values, which may be associated with the hands sections 525, may be outside a range of RGB values that correspond to human skin and as such, may be filtered out. This principle may apply to other articles or materials and other portions of a body, such as long sleeves or cosmetics applied to a person's face.

In some instances, conflicting data about a target 405 may need to be addressed. For example, a target 405 may have dark skin and may be wearing an article of clothing that is similar in color to a light-skin type. In this example, the hands and face of the target 405 may be exposed, revealing dark skin, but the arms of the target 405 may be covered by sleeves with colors that are equivalent to light skin. The spectral angles corresponding to the hands and face of the target 405 may be useful in estimating the preliminary median RGB value, but those related to the sleeve-covered arms may detract from its accuracy.

To overcome the contradiction, processor 110 can be configured to rely on the actual exposed skin and filter out the metrics from the material that is not skin. For example, the processor 110 can compare the RGB values associated with the face section 520, hand sections 525, and arm sections 530 of a target 405 and can filter out those values in the minority or that correspond to portions of a body more likely to be covered by apparel or some other article. In this example, processor 110 can ignore the RGB values related to the arm sections 530—even though they may be within an acceptable range for human skin—because the RGB values of the face section 520 and hand sections 525 are equivalent. That is, two sections roughly in agreement may carry more weight than one. Moreover, the skin corresponding to the face section 520 and hand sections 525 is more likely to be uncovered in comparison to that of the arm sections 530, which may also factor into a weighting scheme.

Other factors may be considered during the estimation of the skin-reference spectral angle and the threshold. For example, if the color of the lighting in the monitoring area 200 changes to a certain degree, the processor 110 may correspondingly adjust the skin-reference spectral angle and the threshold to account for the effect on the spectral angles corresponding to the exposed skin of the targets 405.

In one embodiment, estimating a refined skin-reference color vector once the preliminary skin-reference color vector is obtained may not be necessary. In such a case, the preliminary skin-reference color vector may effectively serve as the refined skin-reference color vector to be used for segmenting out skin detections. Accordingly, the preliminary skin-reference color vector and the preliminary skin-reference spectral angle may be respectively referred to as the skin-reference color vector and the skin-reference spectral angle. Likewise, a preliminary spectral-angle threshold in this instance may be referred to as the threshold for the skin-reference spectral angle. Because the step of estimating the refined skin-reference color vector may be skipped, determining the skin-reference spectral angle for segmenting out skin detections may be performed faster.

Whether to omit the step of estimating a refined skin-reference color vector may depend on the robustness of the preliminary skin-reference spectral angle in segmenting out skin detections. Several factors may contribute to such robustness. In particular, trials related to the subject matter presented herein have shown that skin may be inherently suited for effective segmentations. In addition, the accuracy of estimating the preliminary skin-reference color vector may be increased. For example, the composite binary image of a target 405 may be over-segmented, meaning that some parts of the image are not actually related to the target 405, and adjustments can be made to account for the excessive segmentation. The filter parameters used during the morphological filtering may lead to some pixels unrelated to the target 405 to be used to determine a preliminary median RGB value. As such, a certain fraction or ratio in comparison to the filter parameters may be used to more accurately identify the pixels that are actually related to the target 405. (In many cases, the filter parameters are in numbers of pixels.) For example, if a filter parameter has a fixed value for a certain boundary, the pixels used for extraction of the RGB values may be those that are within one-third of the fixed value. The pixels that fall within the remaining two-thirds of the fixed value may be ignored for the extraction, even though they may be within the boundary established by the filter parameter. This modification may result in greater precision in defining the skin sections to be used for extracting the RGB values for determining the preliminary median RGB value and, hence, a robust skin-reference spectral angle. This skin-reference spectral angle can be used to segment out skin detections in accordance with the description herein. Also, the concepts of ignoring RGB values outside a range defined for skin and resolving conflicts may apply to this procedure.

No matter which procedure is used to estimate the skin-reference color vector, it (and its skin-reference spectral angle) can be stored for later retrieval to segment out skin detections in future frames, as will be explained below. The estimated threshold for the skin-reference spectral angle may also be stored for later retrieval for such segmentation. Once obtained, a single skin-reference spectral angle and its threshold can be used to segment out skin detections for multiple humans later in the monitoring area 200. This skin-reference spectral angle may also be referred to as a common skin-reference spectral angle because it may be applicable with respect to multiple targets. Moreover, the threshold for this single skin-reference spectral angle can be a single (or common), constant value that can be used for segmenting out such skin detections (corresponding to multiple humans), although it may be adaptive in nature as an option. In addition, the humans from which the segmented-out skin detections originate can have equivalent or different skin colors.

As another benefit, the single skin-reference spectral angle and its threshold may be used for segmenting out skin detections of various humans in locations other than the monitoring area 200. That is, these parameters, once estimated, may be applicable in many different locations. The skin-reference spectral angle and the threshold may also be used to segment out skin detections related to humans in multiple lighting conditions, both man-made and natural.

In view of the comprehensive applicability of the skin-reference spectral angle and the threshold, the process of estimating them may occur at locations other than the monitoring area 200 and with use of equipment other than the camera 100 attached to the area 200. For example, a central testing facility, which can simulate various indoor or outdoor configurations and lighting conditions, may be established, and trial subjects (such as humans) may be assembled at the facility. Any number of testing procedures may be conducted at the facility using the trial subjects, and one or more skin-reference spectral angles and their thresholds may be estimated. Following this process, the skin-reference spectral angle(s) and the threshold(s) may be delivered to one or more cameras 100 or other tracking systems for enabling the detection of human skin.

As noted above, a single skin-reference spectral angle and its threshold can be estimated for segmenting out skin detections associated with multiple human targets. In other cases, more than one skin-reference spectral angle and threshold can be determined for such purposes. For example, in accordance with the description above, a first skin-reference color vector and a second skin-reference color vector can be obtained. (Both the first skin-reference color vector and the second skin-reference color vector may be stable skin-reference color vectors.) From these vectors, a first skin-reference spectral angle and a second skin-reference spectral angle may be obtained. (Like the vectors, the first skin-reference spectral angle and the second skin-reference spectral angle may be stable skin-reference spectral angles.) Thresholds for both the first skin-reference spectral angle and the second skin-reference spectral angle may also be estimated. One or both of the first and second skin-reference spectral angles and their thresholds may then be used to segment out skin detections associated with multiple human targets.

In one embodiment, the first skin-reference spectral angle may be based on a first human-skin type, and the second skin-reference spectral angle may be based on a second human-skin type. For example, the first human-skin type may be a light-skin type, and the first skin-reference spectral angle may be a light-skin-reference spectral angle. In addition, the second human-skin type may be a dark-skin type, and the second skin-reference spectral angle may be a dark-skin-reference spectral angle. As part of this example, a light-skin threshold may be estimated for the light-skin-reference spectral angle, and a dark-skin threshold may be estimated for the dark-skin-reference spectral angle.

As part of obtaining these parameters, the reference group 400 may include targets 405 with both light skin and dark skin. In a controlled setting, the reference group 400 may first include only targets 405 with light skin, and the processor 110 can then obtain the light-skin-reference spectral angle and the light-skin threshold. Similarly, the reference group 400 may be rearranged to only include targets 405 with dark skin, and the dark-skin reference spectral angle and the dark-skin threshold may be estimated. If targets 405 with different skin colors are part of the reference group 400, however, other steps may be taken to acquire the reference spectral angles and thresholds. In particular, when extracting the RGB values (for estimating the preliminary or stable skin-reference spectral angles and thresholds, certain values may be ignored. For example, as part of estimating a light-skin reference spectral angle and light-skin threshold, RGB values that may be outside a certain range of values that are normally associated with light skin can be ignored, even though they may correspond to (dark) skin. Likewise, when obtaining a dark-skin reference spectral angle and dark-skin threshold, RGB values that may be related to light skin and, as such, outside the range of values for dark skin may be filtered out. (These procedures may apply to estimations for preliminary or stable skin-reference spectral angles and thresholds.)

Like the skin threshold described above with respect to a single skin-reference spectral angle, the light-skin and dark-skin thresholds may be constant values, or they may be adaptive in nature. Similarly, the value of a light-skin threshold may equal that of a dark-skin threshold, or they can be dissimilar. In one non-limiting example, a skin-threshold with a value of 0.0025 has proven to work well in segmenting out skin detections related to multiple humans of varying skin tones across numerous frames under different monitoring-area configurations. Deviations of plus or minus ten percent or less from this value have also shown to be robust in such circumstances.

In some cases, the skin-reference spectral angles and the thresholds may be immune to some changes in lighting (such as its intensity), meaning they can remain constant (or substantially constant) despite such variations. Other fluctuations in the properties of lighting (such as its spectra), however, may require one or more correction processes to be applied, which can be relied on to obtain a substantially invariant skin reflectance for the targets. For example, in an outdoor setting, the sun spectra may vary based on the time of day or year and current weather. To account for such differences, atmospheric and radiometric correction algorithms may be used to accurately estimate atmospheric parameters for the invariant skin reflectance. Additional information can be found in “Feature Transformation Detection Method with Best Spectral Band Selection Process for Hyper-Spectral Imaging,” Hai-Wen Chen, Mike McGurr, and Mark Brickhouse, Sensing and Imaging, ISSN 1557-2064, Vol. 15, No. 1, published on Jul. 5, 2015, pages 1-33.

Any number of skin-reference spectral angles and skin thresholds may be estimated and stored for detecting human skin. For example, a skin-reference spectral angle and its threshold may be estimated for each skin type of a classification scheme, or a skin-reference spectral angle and accompanying threshold may be estimated for multiple skin types of such a scheme. Thus, any one of a number of skin-reference spectral angles and thresholds (including a single angle and threshold combination) can be used to segment out skin detections for multiple human targets, examples of which will be shown below.

Any suitable system may be used to classify skin types. In one arrangement, the Fitzpatrick scale may be used to classify skin types for purposes of their relevance to certain skin-reference color vectors. For example, under the Fitzpatrick scale, skin color that falls within types I, II, III, and IV may be considered as light skin. As such, targets 405 with these skin types can be used to estimate one or more light-skin-reference spectral angles and light-skin thresholds. In addition, a light-skin-reference spectral angle and light-skin threshold can be employed for purposes of segmenting out light-skin detections associated with humans who have these skin types. In contrast, skin color that aligns with types V and VI of the Fitzpatrick scale may be classified as dark skin. Targets 405 with skin types V and VI may be used to estimate one or more dark-skin-reference spectral angles and dark-skin thresholds, which can be used to segment out dark-skin detections arising from people with such skin types. As an option, additional skin-reference color vectors may be estimated for the different skin types, such as a skin-reference color vector for each specific skin type.

As another example, skin may be classified into certain types based on its reflectance. For instance, skin may be classified as light skin if it has a reflectance signature that peaks around 600-700 nanometers (nm) (or higher) with a reflectance percentage of at least twenty percent at that range. Skin that has a reflectance signature that peaks from about 600 nm to 700 nm (or higher) with a reflectance percentage below twenty percent for this range may be assigned as dark skin. Other peaks in reflectance signatures may be used to classify and distinguish between skin colors, including those that appear with respect to wavelengths of non-visible light, such as near infrared. One or more light- and dark-skin-reference spectral angles and light- and dark-skin thresholds may be estimated for targets 405 with light and dark skin according to this classification. Once estimated, these metrics may also be used to segment out light- and dark-skin detections from humans with skin tones that fall within these wavelengths.

Up to this point, the description related to the method 300 has focused on estimating skin-reference spectral angles and their thresholds, with references to how these parameters can be used to detect human skin. Several examples will be presented to illustrate such a process.

Referring back to the method 300, at step 310, a frame that includes data associated with multiple human targets in a monitoring area may be received. At step 315, spectral angles related to the human targets can be extracted from the frame, and the spectral angles related to the human targets can be compared with a skin-reference spectral angle, as shown at step 320. At step 325, based on the comparison, skin detections associated with the human targets can be segmented out. At step 330, the skin detections can be classified into different body parts based on certain parameters of the skin detections.

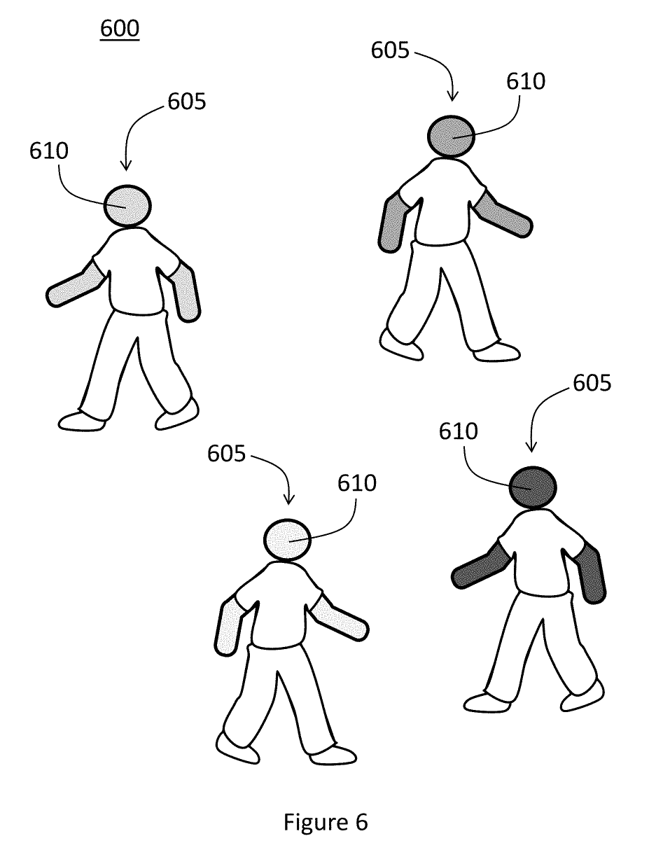

To assist in the explanation of these steps, reference will be initially made to FIG. 6, which presents an example of an RGB frame 600 that shows four full-body detections 605 (in visual form) of multiple human targets 610. These targets 610 are new targets and are different from the targets 405 of the reference group 400 (see FIG. 4), although they may or may not be positioned in the same monitoring area 200. Moreover, the RGB frame 600 is a new (or future) frame and is different from the RGB frame 500 (see FIG. 5). As can be seen, the targets 610 may have various skin colors, and the number of them may be at least two. In accordance with concepts previously described, composite binary images can be formed, which can enable detection data to be obtained for the targets 610. Examples of detection data may be like that described earlier, including the number and X, Y positioning of the pixels, X and Y spans, deviation from a rectangular shape, LWR or HWR, or an estimated centroid.

In one arrangement, the processor 110, based on the detection data, can use the X and Y positioning of all the pixels associated with the full-body detections to obtain from the RGB frame 600 the spectral angles of these pixels. The processor 110 can also compare one or more skin-reference spectral angles to the spectral angles of the pixels related to the full-body detections 605. Groupings of pixels with spectral angles that fall within the threshold for the skin-reference spectral angle can be segmented out from the full-body detections 605. Like the description above related to estimating the skin-reference color vectors, to fall within the threshold for the skin-reference spectral angle for this comparison, the spectral angles may equal the value of the skin-reference spectral angle, be below or above such value, or equal and be below or above such value. In this example, a match includes a spectral angle with a value that equals or is below that of the skin-reference spectral angle. In either case, this step can identify skin patches or detections of the full-body detections 605. Confidence factors, which may indicate the probability of a match, can be assigned to one or more (including all) the skin detections. If a single skin-reference spectral angle is used, this segmentation can lead to skin detections for multiple targets 610 in a monitoring area 200. In fact, if the camera 100 is placed in a different location or the single skin-reference spectral angle is provided to another camera in the different location, the single skin-reference spectral angle can be used to realize skin detections from multiple targets in the different location.

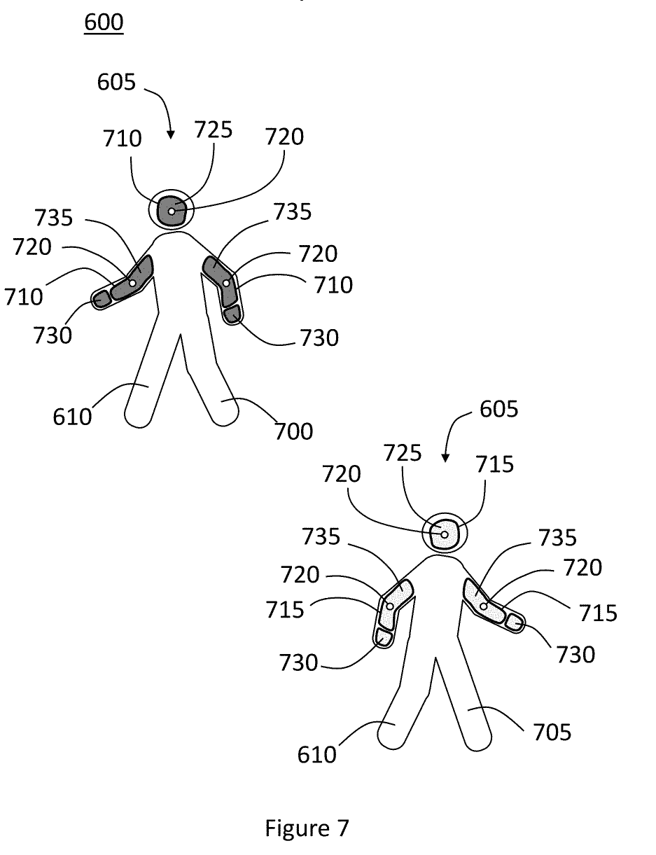

As described above, more than one skin-reference spectral angle may be used to segment out skin detections. For example, referring to FIG. 7, the RGB frame 600 is presented again, including two of the full-body detections 605 of the targets 610. In this example, one target 610 may have dark skin, referred to as a dark-skin target 700, and the other target 610 may have light skin, which may be referred to as a light-skin target 705. Also in this example, the camera 100 may be configured with both dark-skin- and light-skin-reference color vectors, meaning both dark-skin- and light-skin-reference spectral angles may be available for segmenting out skin detections. In accordance with the previous discussion surrounding classification of skin-color types, the targets 610 may be considered to have dark or light skin based on any suitable scheme.

Using the dark-skin-reference spectral angle, groupings of pixels that have spectral angles that fall within the dark-skin threshold of the dark-skin-reference spectral angle may be segmented out from the full-body detections 605. Examples of several dark-skin detections 710 that are associated with the dark-skin targets 700 are illustrated in FIG. 7. Similarly, using the light-skin reference spectral angle can enable light-skin detections 715 related to the light-skin targets 705 to be segmented out. In this example, as a visual reference, the dark-skin detections 710 and the light-skin detections 715 are shown by boxes with solid outlines. Thus, a single skin-reference color vector (and, hence, a single skin-reference spectral angle) can be used to segment out skin detections associated with multiple human targets based on a dark-skin-color type, and the same can be done with another single skin-reference color vector (and skin-reference spectral angle) in relation to multiple targets with a light-skin-color type.

In one arrangement, as part of segmenting out skin detections, the camera 100 can be configured to classify the skin detections into different body parts. To enable this feature, the processor 110 may perform a detection process with respect to the skin detections, which can be like that conducted for the full-body detections, as presented earlier. For example, for each of the dark-skin detections 710 and light-skin detections 715, the processor 110 may estimate the X and Y positions of a centroid 720, its number of pixels and their X and Y positions, its height-to-width or length-to-width ratios (HWR or LWR), or its deviation from a rectangular shape. The processor 110 may also estimate other parameters, including those in relation to a full-body detection 605. As an example, the position of the centroid 720 with respect to the centroid or the upper or lower edges (and in relation to one another) of a full-body detection 605, such as the upper or lower limits of a bounding box or X or Y span of the full-body detection 605, can be recorded as part of the detection data of a skin detection. The detection data for a skin detection is not necessarily limited to the parameters listed here.

As an example of a classification, the processor 110 may classify some of the dark-skin detections 710 and light-skin detections 715 as face detections 725 (or simply, faces) based on the number of pixels and the shapes of the detections, which may be roughly rectangular and exhibit a certain HWR or LWR. As another example, the positioning of the centroids 720 of the skin detections in relation to centroid or the upper edges of a nearby full-body detection 605 may also factor into this classification. (The centroid 720 of a skin detection may be located above but possibly in the same vertical plane as a centroid of the nearby full-body detection 605.) The neck of a target 610 may or may not form part of a face detection 725. As another example, the processor 110 may classify some of the dark-skin detections 710 and light-skin detections 715 as hand detections 730 (or hands) and arm detections 735 (or arms). Like the face detections 725, the number of pixels of the detections and their shapes may form the basis of this classification. Comparing the positioning of the centroids 720 of the skin detections with detection data from a nearby full-body detection 605 may also be part of this classification process. As an example, a skin detection corresponding to an arm may deviate significantly from a rectangular shape, but one related to a hand may not. Other dark-skin detections 710 and light-skin detections 715 can be similarly classified, such as leg detections 740. Confidence factors may also be assigned to any of the classifications.

In some cases, a skin detection may be formed by two different body-part classifications. For example, a skin detection may correspond to the entire arm of a target 610, which is realized from the skin of the arm and the hand. The processor 110 can classify this skin detection into several sub-detections, such as a hand detection 730 and an arm detection 735. This feature can enable skin detections to be classified into any number and type of sub-detections. As part of this technique, the processor 110 can analyze the detection data of the skin detection to categorize the skin detection into its parts. In this example, the processor 110 could identify part of the initial (whole) arm detection as a hand detection 730 based on the size, shape, and/or positioning of the pixels that make up this section of the initial arm detection. Reference could also be made to the detection data of a nearby full-body detection 610, as explained above. The processor 110 could also classify the remaining part of the initial arm detection as an arm detection 735 based on a similar analysis.

As an option, the classifications can be made more or less granular. For example, the classification of a skin detection can be narrowed down to certain orientations or perspectives, such as categorizing a leg detection (not shown) as a front or back leg detection (with respect to the camera 100) or a right or left leg detection. As another example, a face detection 725 can be classified as a front or profile face detection 725. As an example of less granularity, a face detection 725 could be classified as simply an upper-body skin detection.

As new frames are received, the process of segmenting out skin detections may be repeated, even as human targets leave a monitoring area or new human targets enter it. Moreover, the same skin-reference color vectors (and skin-reference spectral angles and their thresholds), no matter how many of them are estimated and stored, can be used to realize the skin detections, even if the skin color of the new targets is significantly different from that of previous targets. In addition, the segmentation may be unaffected by some changes in the lighting in a monitoring area, and the skin-reference spectral angles and their thresholds, once estimated, may be used in different monitoring areas. In one option, if the performance of the camera degrades, one or more new skin-reference spectral angles and thresholds may be estimated or retrieved from memory and used for segmenting out skin detections or correction processes may be applied, as previously described.

The ability to segment out skin detections, in accordance with the description herein, can bolster the performance of passive-tracking systems, particularly with respect to constellation information of a target. For example, knowing the position and orientation of the body parts of one or more targets being tracked can enable such a system to estimate the condition of a target, such as whether the target is directly facing a camera or is in a seated position. This information may also enhance the ability of a system to estimate the type of activity performed by one or more targets, such as running or fighting.

Although the solutions described herein primarily focus on indoor settings, the camera may can operate in areas that are not enclosed or sheltered. For example, the camera may be positioned in areas that are exposed to the environment, such as open locations in amusement parks, zoos, nature preserves, parking lots, docks, or stadiums. Environmental features, like sunlight patterns, foliage, snow accumulations, or water pooling, may be eliminated as background clutter. Moreover, even though the description herein focuses primarily on humans as targets, the principles described herein may apply to skin from any living being or to certain uniform (or substantially uniform) surfaces, including those for a machine, that may be used to segment out detections for multiple targets using a common reference spectral angle. Additionally, because this solution is geared towards a visible-light camera, the techniques and processes described herein may be implemented by simply retrofitting existing camera systems.

The flowcharts (if any) and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

What is claimed is:

1. A camera for detecting human skin, comprising:
an image-sensor circuit configured to generate a frame of a monitoring area that includes data associated with multiple human targets in the monitoring area; and
a processor configured to:
receive the frame from the image-sensor circuit;
compare spectral angles related to the human targets and extracted from the frame with a single skin-reference spectral angle; and
based on the comparison of the spectral angles related to the human targets with the skin-reference spectral angle, segment out skin detections associated with the human targets.

2. The camera of claim 1, wherein the processor is further configured to:
estimate the skin-reference spectral angle based on a reference group of humans; and
estimate a threshold for the skin-reference spectral angle.

3. The camera of claim 2, wherein the processor is configured to segment out the skin detections associated with the human targets when the spectral angles related to the human targets fall within the threshold for the skin-reference spectral angle.

4. The camera of claim 3, wherein the processor is further configured to:
store the skin-reference spectral angle; and
compare spectral angles related to the human targets in the monitoring area and extracted from a future frame with the skin-reference spectral angle, wherein the future frame includes data associated with the human targets.

5. The camera of claim 4, wherein the processor is further configured to compare spectral angles related to new human targets in the monitoring area and extracted from another future frame with the skin-reference spectral angle, wherein the other future frame includes data associated with the new human targets.

6. The camera of claim 1, wherein the processor is further configured to classify the skin detections associated with the human targets into one or more body-part classifications.

7. The camera of claim 6, wherein the processor is configured to classify the skin detections based on one or more parameters of the skin detections, wherein the parameters include the size, shape, or position of the skin detections.

8. A camera for detecting human skin, comprising:
an image-sensor circuit configured to generate a frame of a monitoring area that includes data associated with multiple human targets in the monitoring area; and
a processor configured to:
receive the frame from the image-sensor circuit;
compare spectral angles related to the human targets and extracted from the frame with a first skin-reference spectral angle and a second skin-reference spectral angle, wherein the first skin-reference spectral angle is based on a first human-skin type and the second skin-reference angle is based on a second human-skin type; and
based on the comparison of the spectral angles related to the human targets with the first skin-reference spectral angle and the second skin-reference spectral angle, segment out skin detections associated with the human targets.

9. The camera of claim 8, wherein the first skin-reference spectral angle is a light-skin-reference spectral angle and the first human-skin type is a light-skin type and wherein the second skin-reference spectral angle is a dark-skin reference spectral angle and the second human-skin type is a dark-skin type.

10. The camera of claim 9, wherein a portion of the human targets have light-skin types and another portion of the human targets have dark-skin types and wherein the skin detections associated with the human targets segmented out by the processor include both light-skin detections and dark-skin detections.

11. The camera of claim 10, wherein the processor is further configured to:
estimate the light-skin reference spectral angle based on a reference group of humans with light-skin types;
estimate a light-skin threshold for the light-skin reference spectral angle;
estimate the dark-skin reference spectral angle based on a reference group of humans with dark-skin types; and
estimate a dark-skin threshold for the dark-skin reference spectral angle.

12. The camera of claim 11, wherein the processor is configured to:
segment out the light-skin detections when the spectral angles related to the human targets fall within the light-skin threshold for the light-skin-reference spectral angle; and
segment out the dark-skin detections when the spectral angles related to the human targets fall within the dark-skin threshold for the dark-skin-reference spectral angle.

13. The camera of claim 11, wherein both the light-skin reference spectral angle and the dark-skin reference spectral angle are reusable for comparisons with spectral angles extracted from future frames of the monitoring area or a new monitoring area.

14. The camera of claim 11, wherein the light-skin threshold is constant with respect to the light-skin reference spectral angle and the dark-skin threshold is constant with respect to the dark-skin reference spectral angle.

15. The camera of claim 14, wherein, in addition to being constant with respect to the light-skin reference spectral angle, the light-skin threshold is constant with respect to the monitoring area or a new monitoring area and wherein, in addition to being constant with respect to the dark-skin reference spectral angle, the dark-skin threshold is constant with respect to the monitoring area or the new monitoring area.

16. The camera of claim 8, wherein the processor is further configured to classify the skin detections based on one or more parameters of the skin detections, wherein the parameters include the size, shape, or position of the skin detections.

17. A method of detecting human skin, comprising:
receiving a frame that includes data associated with multiple human targets in a monitoring area;
extracting from the frame spectral angles related to the human targets;
comparing the spectral angles related to the human targets with a first skin-reference spectral angle; and
based on comparing the spectral angles related to the human targets with the first skin-reference spectral angle, segmenting out skin detections associated with the human targets.

18. The method of claim 17, further comprising:
comparing the spectral angles related to the human targets with a second skin-reference spectral angle; and
based on comparing the spectral angles related to the human targets with the second skin-reference spectral angle, segmenting out additional skin detections associated with the human targets.

19. The method of claim 18, further comprising:
estimating the first skin-reference spectral angle based on a first set of skin colors and;
estimating the second skin-reference spectral angle based on a second set of skin colors.

20. The method of claim 17, further comprising classifying the skin detections based on one or more parameters of the skin detections, wherein the parameters include the size, shape, or position of the skin detections.
